(19) United States
(12) Patent Application Publication
(10) Pub. No.: US 2007/0232224 A1
(43) Pub. Date: Oct. 4, 2007

(54) DIGITAL BROADCAST RECEIVER

(76) Inventors: Takeshi HOSHINO, Kodaira (JP); Maki Furui, Tokyo (JP); Toshiyuki Moriya, Tokorozawa (JP); Yoshiaki Suzuki, Kawasaki (JP); Sergio Paolantonio, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/693,047

(22) Filed: Mar. 29, 2007

(30) Foreign Application Priority Data
Mar. 30, 2006 (JP) 2006-093154

(51) Int. Cl. H04H 7/00; H04B 1/38

(52) U.S. Cl. 455/3.06; 455/566

(57) ABSTRACT

In a digital broadcast receiver, program videos of digital broadcasts are switched with ease of use, and quickly displayed. A digital broadcast receiver receives digital broadcasts and processes data contained in the broadcasts to display program videos. The digital broadcast receiver includes: a tuner part having a first tuner and a second tuner; a display part; an input part; and a control part. The input part generates a first operation signal when operation buttons are touched, and generates a second operation signal when the operation buttons are pushed. The control part starts the reception of a program corresponding to the first operation signal by the second tuner when detecting the first operation signal during the display of a program video being received over the first tuner, and when detecting the second operation signal, switches to the display of a program video being received over the second tuner.

### CLAIM OF PRIORITY

The present application claims priority from Japanese application JP 2006-093154 filed on Mar. 30, 2006, the content of which is hereby incorporated by reference into this application.

### BACKGROUND OF THE INVENTION

(1) Field of the Invention

The present invention relates to digital broadcast receivers, and more particularly to a digital broadcast receiver that receives digital broadcasts and allows program videos displayed in a display part to be switched by user's operations on an input part.

(2) Description of the Related Art

A conventional digital broadcast receiver is disclosed in, for example, Japanese Patent Application Laid-Open No. 2005-136477. The digital broadcast receiver includes a tuner part, a control part (CPU), a display part (display), a voice output part (loudspeaker), and a storing part (ROM), an operation signal light receiving part, and a remote controller (remote commander). The tuner part includes a first tuner corresponding to terrestrial digital broadcasts and a second tuner corresponding to BS (Broadcasting Satellite) and CS (Communication Satellite) to be capable of receiving plural digital broadcasts. The control part is constructed to perform control of the switching of broadcast channels and BS/CS digital broadcasts according to operation signals inputted from a remote controller.

Recently, digital broadcasts such as terrestrial digital broadcasts, BS digital broadcasts, and CS digital broadcast have come into widespread use, and various digital broadcast receivers including Japanese Patent Application Laid-Open No. 2005-136477 have been devised. However, in digital broadcast receivers, generally, a time lag of about one second occurs from the reception of digitized data until decoded data is displayed. Although users do not mind the time lag itself while enjoying program videos, when channel changing within an identical digital broadcast and switching among different digital broadcasts are performed to switch program videos, the display of the program videos delays by time lag, forcing the users to wait for the display of the program videos by the time lag.

On the other hand, when the users become interested in programs broadcast over other channels when enjoying a program video, they have found it very inconvenient to switch channels by operating the remote controller to temporarily stop the current program video and browse other program videos.

Some broadcast receivers can display program videos at the same time on two screens by functions such as double windows and Picture in Picture. Such concurrent display of program videos on two screen, inconveniently to the users, requires troublesome operations such as the activation of such a special function, channel selection on the both screens, and restoration to a full screen after the decision of a desired program, and frequent looks at remote controller buttons at hand for confirmation.

An increasing number of visually handicapped persons enjoy program voice by digital broadcast receivers. In this case, in addition to program information such as EPG (Electronic Program Guide) displayed on a screen, the provision of voice-based program information is desired.

An object of the present invention is to provide a digital broadcast receiver that enables program videos of digital broadcasts to be switched with ease of use and quickly displayed.

### SUMMARY OF THE INVENTION

To achieve the above-described object, the present invention is a digital broadcast receiver that receives a digital broadcast and processes data contained in the broadcast to display a program video, including: a tuner part having a first tuner and a second tuner; a display part that displays a program video processed by the tuner part; an input part having operation buttons for selecting programs; and a control part that controls them in an integrated manner. The input part generates a first operation signal when the operation buttons are touched, and generates a second operation signal when the operation buttons are pushed. The control part starts the reception of a program corresponding to the first operation signal by the second tuner when detecting the first operation signal during the display of a program video being received over the first tuner, and when detecting the second operation signal, switches to the display of a program video being received over the second tuner.

More desirable embodiments of the present invention are as follows:

(1) The digital broadcast receiver includes the input part, constructed with a remote controller, that has the operation buttons and a remote controller communication part that issues operation signals by operations on the operation buttons, and a main body communication part that receives operation signals issued from the remote controller communication part and inputs them to the control part.

(2) The input part is an input part of two-step action including a pressure touch sensor that generates the first operation signal when the operation buttons are touched, and a tact switch that generates the second operation signal when the operation buttons are pushed.

(3) Even when the detection of the first operation signal goes out after it is detected, the control part continues to receive the program by the second tuner until a predetermined time elapses, and if the second operation signal is not detected until the predetermined time elapses, terminates the reception of the program by the second tuner.

(4) When detecting the first operation signal during the display of a program video being received over the first tuner, the control part displays information about a program corresponding to the first operation signal, along with the program video being displayed.

(5) The tuner part includes the first and the second tuners that process data contained in digital broadcasts in a full version, and a third tuner that processes data contained in digital broadcasts in a simple version. Information about the program corresponding to the first operation signal includes a program video of the simple version processed by the third tuner.

(6) The digital broadcast receiver includes a voice output part that outputs voice, and the control part vocally outputs information about a program corresponding to the first operation signal from the voice output part when detecting the first operation signal during the display of a program video being received over the first tuner.

(7) The main body communication unit and the remote controller communication unit are constructed to be capable of wirelessly sending and receiving signals to and from each other. The digital broadcast receiver includes a voice output part including a first voice output part and a second voice output part incorporated in the remote controller. The control part vocally outputs voice information about a program video displayed in the display part from the first voice output part, and vocally outputs voice information about a touched operation button from the second voice output part.

(8) The control part makes voice outputted from the second voice output part louder than voice outputted from the first voice output part.

(9) The control part lowers voice outputted from the first voice output part that is in the same voice range as the range of voice outputted from the second voice output part.

The present invention can provide a digital broadcast receiver that enables program videos of digital broadcasts to be switched with ease of use and quickly displayed.

### BRIEF DESCRIPTION OF THE DRAWINGS

The invention will be more particularly described with reference to the accompanying drawings, in which:

FIG. 1 is a block diagram showing a digital broadcast receiver of a first embodiment of the present invention;

FIG. 2 is a plan view of a remote controller of FIG. 1;

FIG. 3 is a sectional schematic diagram of the remote controller of FIG. 2;

FIGS. 4A and 4B are drawings for explaining button operations of the remote controller of FIG. 2;

FIG. 5 is an operation flowchart of the digital broadcast receiver of FIG. 1;

FIG. 6 is a drawing showing a first display screen example corresponding to the operation flowchart of FIG. 5;

FIG. 7A is a drawing showing a second display screen example corresponding to the operation flowchart of FIG. 5;

FIG. 7B is a drawing showing a third display screen example corresponding to the operation flowchart of FIG. 5;

FIG. 7C is a drawing showing a fourth display screen example corresponding to the operation flowchart of FIG. 5;

FIG. 8A is a drawing showing a fifth display screen example corresponding to the operation flowchart of FIG. 5;

FIG. 8B is a drawing showing a sixth display screen example corresponding to the operation flowchart of FIG. 5;

FIG. 8C is a drawing showing a seventh display screen example corresponding to the operation flowchart of FIG. 5;

FIG. 9 is a block diagram showing a digital broadcast receiver of a second embodiment of the present invention;

FIG. 10A is a drawing showing a first screen example in the digital broadcast receiver of FIG. 9;

FIG. 10B is a drawing showing a second screen example in the digital broadcast receiver of FIG. 9;

FIG. 10C is a drawing showing a third screen example in the digital broadcast receiver of FIG. 9;

FIG. 11 is a block diagram showing a digital broadcast receiver of a third embodiment of the present invention;

FIG. 12 is a plan view of a remote controller of FIG. 11;

FIG. 13 is a sectional schematic diagram of the remote controller of FIG. 12; and

FIG. 14 is a drawing for describing a voice reduction method in the third embodiment.

### DETAILED DESCRIPTION OF THE PREFERRED EMBODIMENTS

Hereinafter, preferred embodiments of the present invention will be described in detail with reference to the accompanying drawings. Identical reference numerals in the drawings of the embodiments indicate identical things or equivalent things.

### First Embodiment

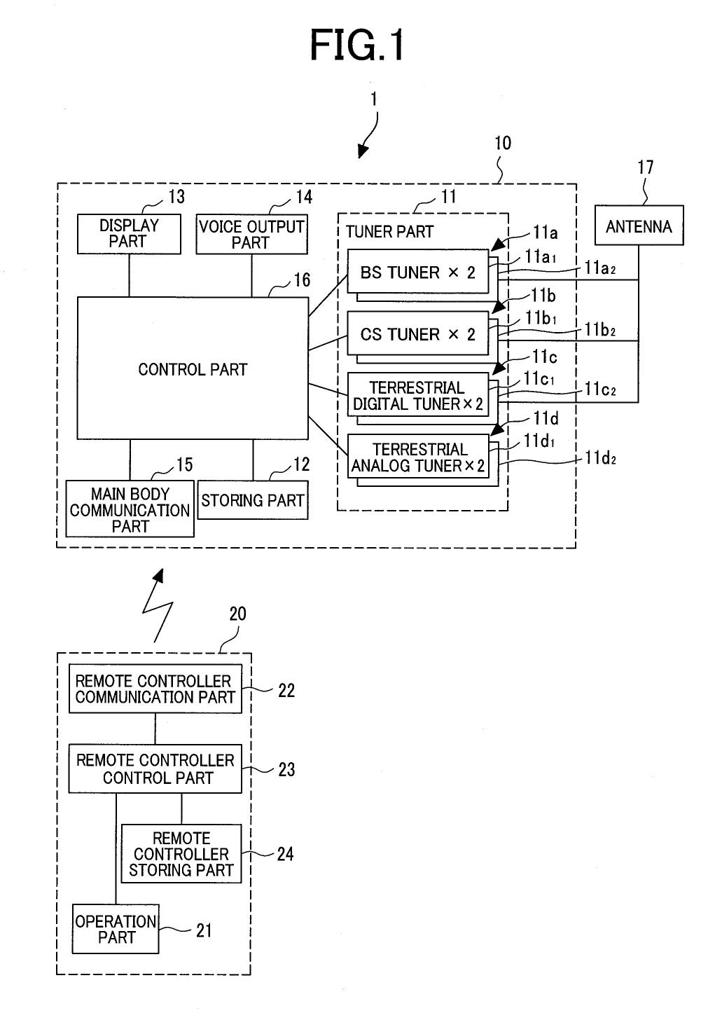

A digital broadcast receiver of a first embodiment of the present invention will be described with reference to FIGS. 1 to 8C.

The whole of a digital broadcast receiver 1 of this embodiment will be described with reference to FIG. 1. FIG. 1 is a block diagram showing a digital broadcast receiver 1 of a first embodiment of the present invention. Although a common TV receiver is described as an example in this embodiment, the present invention allows personal computers and cellular phone terminals that are capable of receiving digital broadcasts to be applied as digital broadcast receivers as well.

The digital broadcast receiver 1 receives plural digital broadcasts such as terrestrial digital broadcasts, BS digital broadcasts, and CS digital broadcasts, and processes data contained in the broadcasts to display program videos. The digital broadcast receiver 1 includes a main body 10 of the receiver, and a remote controller 20.

The main body 10 of the receiver includes a tuner part 11, a main body storing part 12, a display part 13 that displays program videos, etc., a voice output part 14, a main body communication part 15, and a main body control part 16 that totally controls them. A storing part in the digital broadcast receiver 1 includes the main body storing part 12 and a remote controller storing part 24 described later. A control part in the digital broadcast receiver 1 includes the main body control part 16, and a remote controller control part 23 described later.

The tuner part 11 processes data contained in digital broadcasts received by the antenna 17, and has plural tuners including a BS tuner 11a, a CS tuners 11b, a terrestrial digital tuner 11c, and a terrestrial analog tuner 11d.

The BS tuner 11a processes data contained in BS digital broadcasts received by the antenna 17, and includes plural tuners 11a₁ and 11a₂. The CS tuners 11b processes data contained in CS digital broadcasts received by the antenna 17, and includes plural tuners 11b₁ and 11b₂. The terrestrial digital tuner 11c processes data contained in terrestrial digital broadcasts received by the antenna 17, and includes plural tuners 11c₁ and 11c₂. The terrestrial analog tuner 11d processes data contained in terrestrial analogue broadcasts received by the antenna 17, and includes plural tuner 11d₁ and 11d₂. These tuners for digital broadcast process data contained in digital broadcasts received by the antenna 17 in a full version.

A first tuner and a second tuner in the present invention are determined depending on receiving states of programs and operation states; they are not fixed when a large number of tuners exist.

The main body storing part 12 previously stores execution programs and various types of data, and stores data contained in received digital broadcasts such as EPG data. The EPG data is created by decoding broadcasts received through the tuner part 11.

The display part 13 has a display screen, and comprises display panels such as a PDP (plasma display panel) and a liquid crystal display panel.

The voice output part 14 includes a loudspeaker or the like that outputs voice. The voice output part 14, mounted in an upper or lower portion, or left or right side of the display part 13, vocally outputs voice information about a program video and a program displayed in the display part 13.

The main body communication part 15, which performs communications with the remote controller 20, includes an infrared receiving part. A command signal issued using infrared rays from the remote controller 20 is received in the main body communication part 15, and is sent to the main body control part 16.

The main body control part 16 controls the individual parts according to command signals from the remote controller 20. Under control of the main body control part 16, a digital broadcast received by the antenna 17 is processed in the tuner part 11, processed program video is displayed in the display part 11, and processed voice information is supplied to the voice output part 13 to output voice. According to an operation signal (code) sent from the remote controller 20, the main body control part 16 reads text data corresponding to the operation signal from the main body storing part 12, and executes a voice synthesizing algorithm to output voice from the voice output part 14.

The remote controller 20, which constitutes an input part, includes an operation part 21, a remote controller communication part 22, the remote controller control part 23, and the remote controller storing part 24.

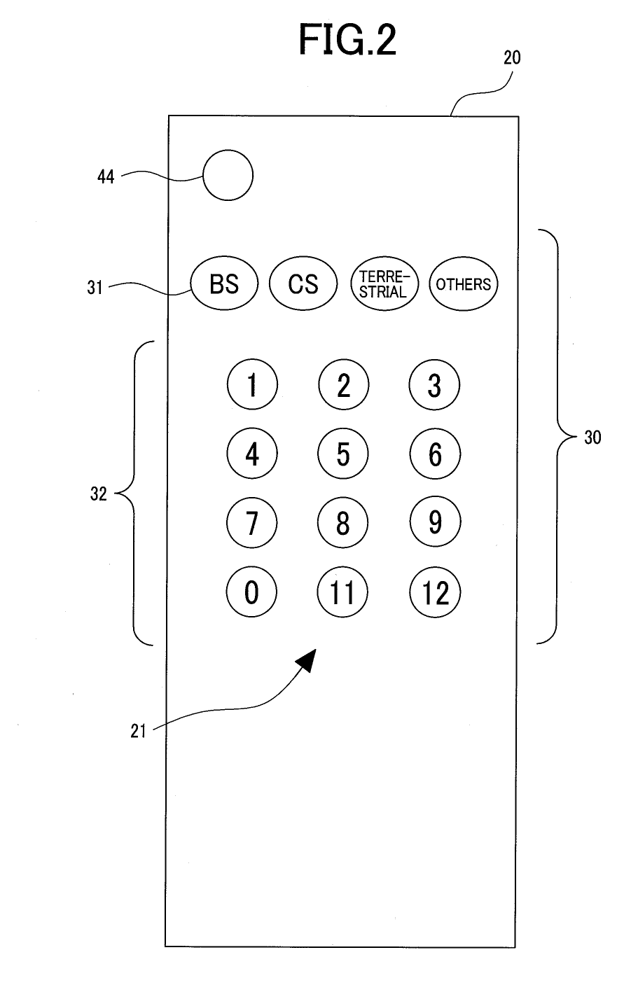

The remote controller 20, when a user's finger or the like touches operation buttons 30 (see FIGS. 2 to 4), generates a first operation signal, and when the operation buttons 30 are pushed by the user's finger or the like, generates a second operation signal. By such a construction, the user can generate the first and the second operation signals in chronological order by a series of usual operations of touching any one of the operation buttons 30, then pushing it. Therefore, the remote controller 20 can generate the two chronological operation signals without having to perform cumbersome operations.

On detecting the first operation signal during display of a program video received by a first tuner (e.g., the BS tuner 11a₁), the main body control part 16 starts the reception of a program corresponding to the first operation signal by a second tuner (e.g., the BS tuner 11a₂), and on detecting a second operation signal, switches to the display of a program video being received by the second tuner (BS tuner 11a₂). Specifically, when a user wants to view a program other than a program being displayed, the user touches any one of the operation buttons 30. By doing so, the reception of a program corresponding to the operation button 30 is started. Then, when the operation button 30 is further pushed to display the program video, the display has already been made ready, and therefore the user can immediately display the program video. Yet, until the operation button 30 is further pushed to change the display mode, since program video having been displayed can continue to display, the user can longer enjoy the program video being displayed, and uncomfortable feeling during program switching can be reduced.

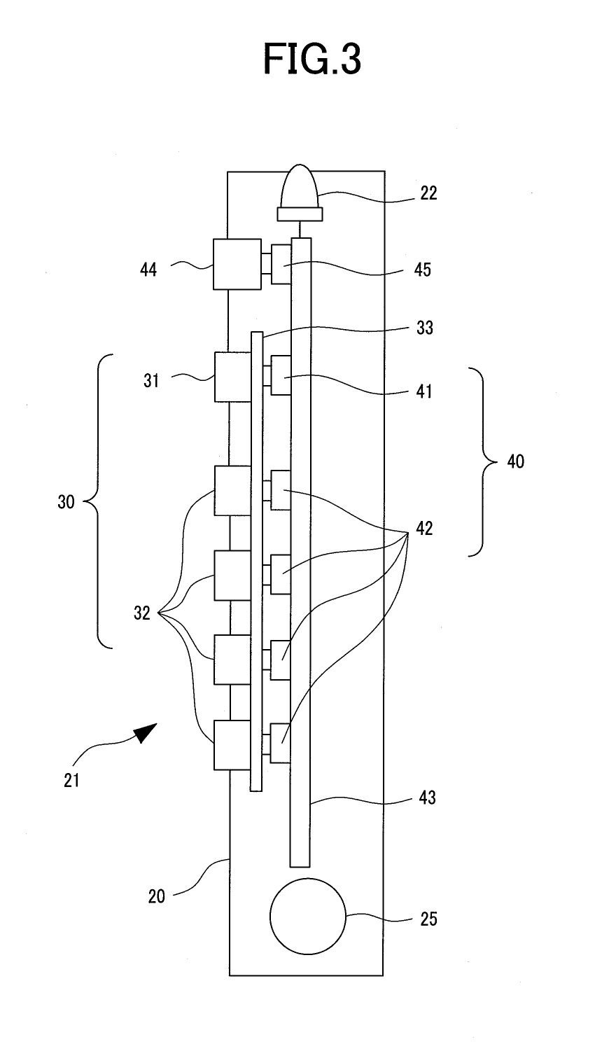

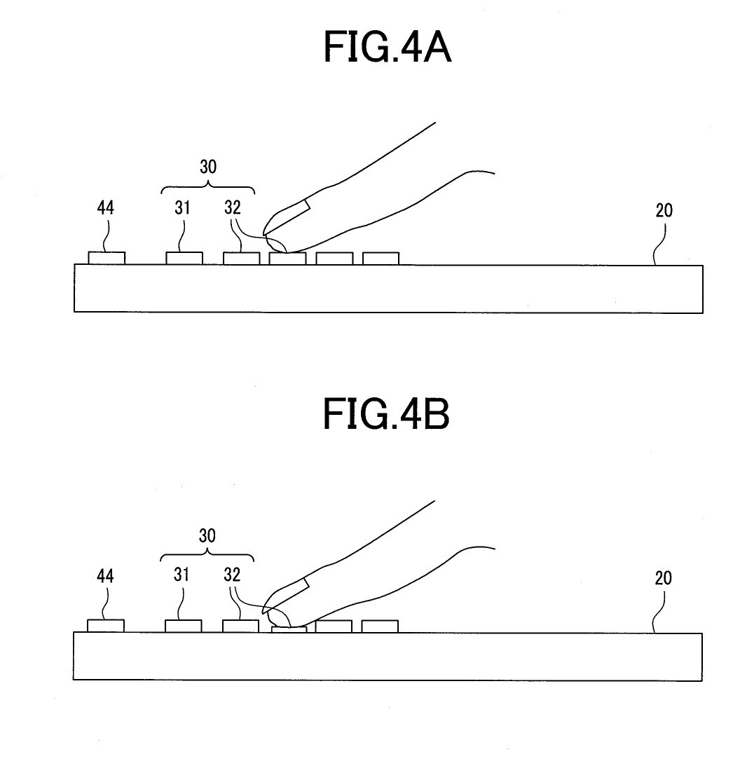

The following describes in detail the remote controller 20 with reference to FIG. 2, FIG. 3, FIG. 4A, and FIG. 4B. FIG. 2 is a plan view of the remote controller 20 of FIG. 1, FIG. 3 is a sectional schematic diagram of the remote controller 20 of FIG. 2, and FIGS. 4A and 4B are drawings for explaining button operations of the remote controller of FIG. 2. FIG. 4A shows a state in which a user's finger touches an operation button 30, and FIG. 4B shows a state in which the operation button 30 is further pushed by the user's finger from the state of FIG. 4A.

The remote controller 20 includes the operation part 21, the remote controller communication part 22, and a battery 25. The operation part 21 includes the operation buttons 30, a first circuit substrate 33, an operation tact switch 40, a second circuit substrate 43, a power button 44, and a power tact switch 45.

The operation buttons 30 include a group of buttons including broadcast mode buttons 31 and channel buttons 32. The broadcast mode buttons 31 are operated by the user to select any one of plural digital broadcast modes such as terrestrial digital broadcast mode, BS digital broadcast mode, CS digital broadcast mode, and analog broadcast mode. The channel buttons 32 are operated by the user to select any one of channels in a broadcast mode selected by the broadcast mode buttons 31.

The broadcast mode buttons 31 and the channel buttons 32 are mounted on the first circuit substrate 33. When the user touches any one of the broadcast mode buttons 31 or the channel buttons 32 with his (her) finger or the like, the touched broadcast mode button 31 or channel button 32 senses contact pressure, and the sensed signal is sent to the remote controller control part 23. For example, as shown in FIG. 4A, when the user touches a channel button 32 with his (her) finger, the touched channel button 32 senses contact pressure, the sensed signal is sent to the remote controller control part 23. The remote controller control part 23 reads out a predetermined control signal code from the remote controller storing part 24 according to the detection result, and uses it as a first operation signal. The first operation signal is sent to the main body communication part 15 from the remote controller communication part 22, and is inputted to the main body control part 16 from the main body communication unit 15.

The operation tact switch 40 includes a broadcast mode tact switch 41 and channel tact switches 42. The broadcast mode tact switch 41 is provided corresponding to the broadcast mode button 31. The channel tact switches 42 are provided corresponding to the channel buttons 32.

The broadcast mode tact switch 41 and the channel tact switches 42 are mounted on the second substrate 43. When the user pushes the broadcast mode button 31 or the channel button 32, a broadcast mode tact switch 41 or channel tact switch 42 that corresponds to the pushed broadcast mode button 31 or channel button 32 is closed, and the close signal is sent to the remote controller control part 23. For example, as shown in FIG. 4B, when the user pushes a channel button 32, a channel tact switch 42 corresponding to the channel button 32 is closed, and the close signal is sent to the remote controller control part 23. The remote controller control part 23 generates a predetermined control signal code according to on the detection result, and uses it as a second operation signal. The second operation signal is sent to the main body communication part 15 from the remote controller communication part 22, and is inputted to the main body control part 16 from the main body communication part 15.

The power button 44 is mounted on the same surface as the operation buttons 30. The power tact switch 45 is mounted on the second circuit substrate 43, and is closed when the power button 44 is pushed.

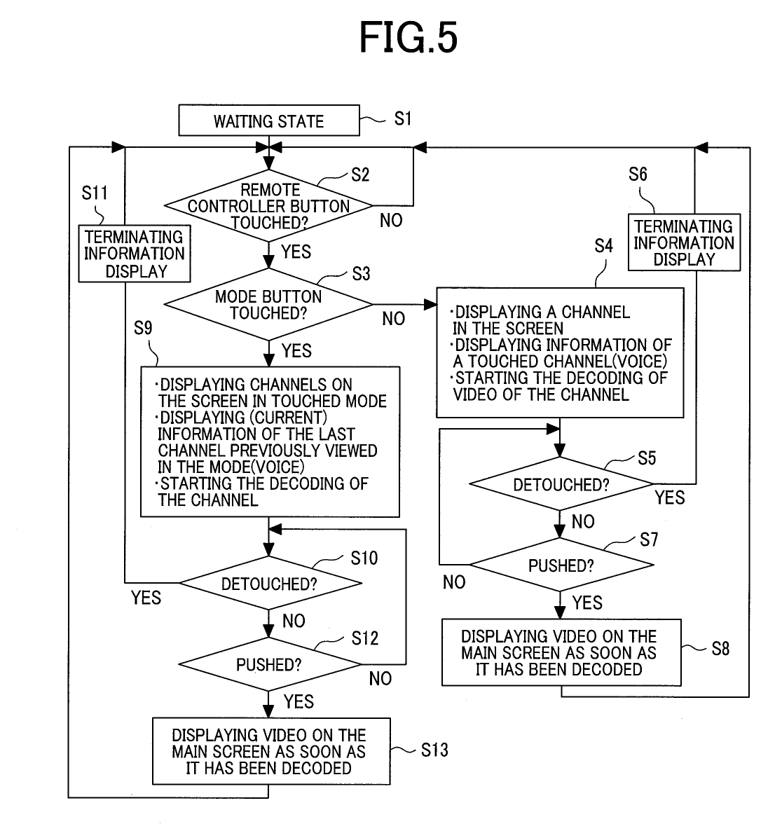

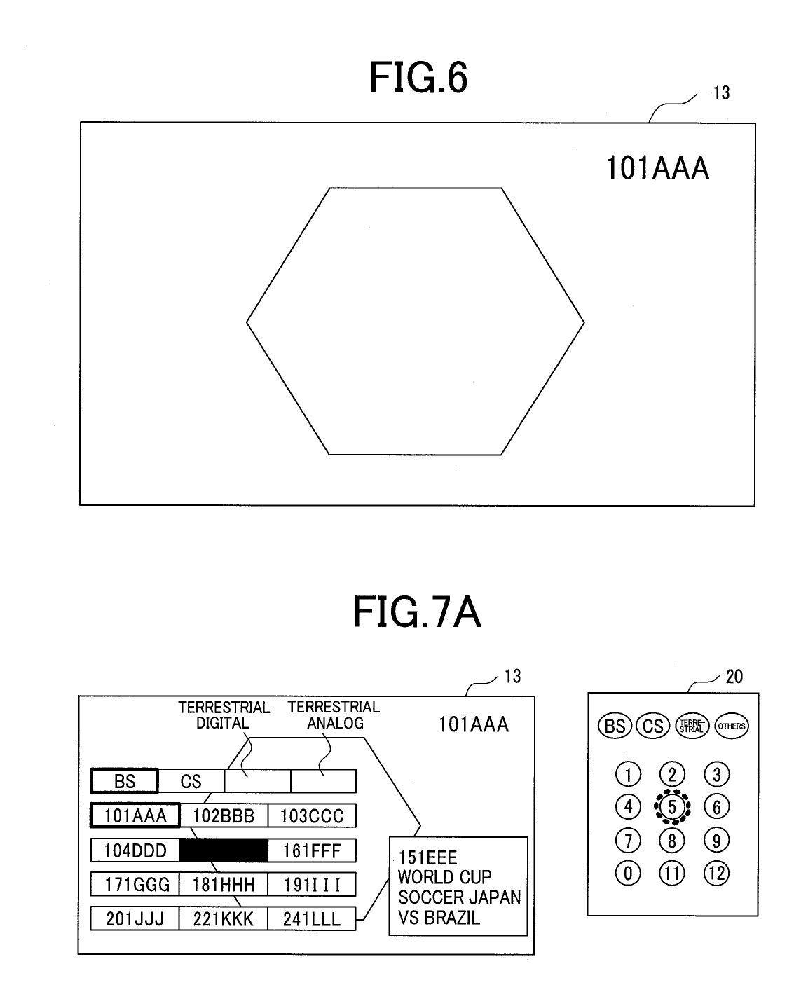

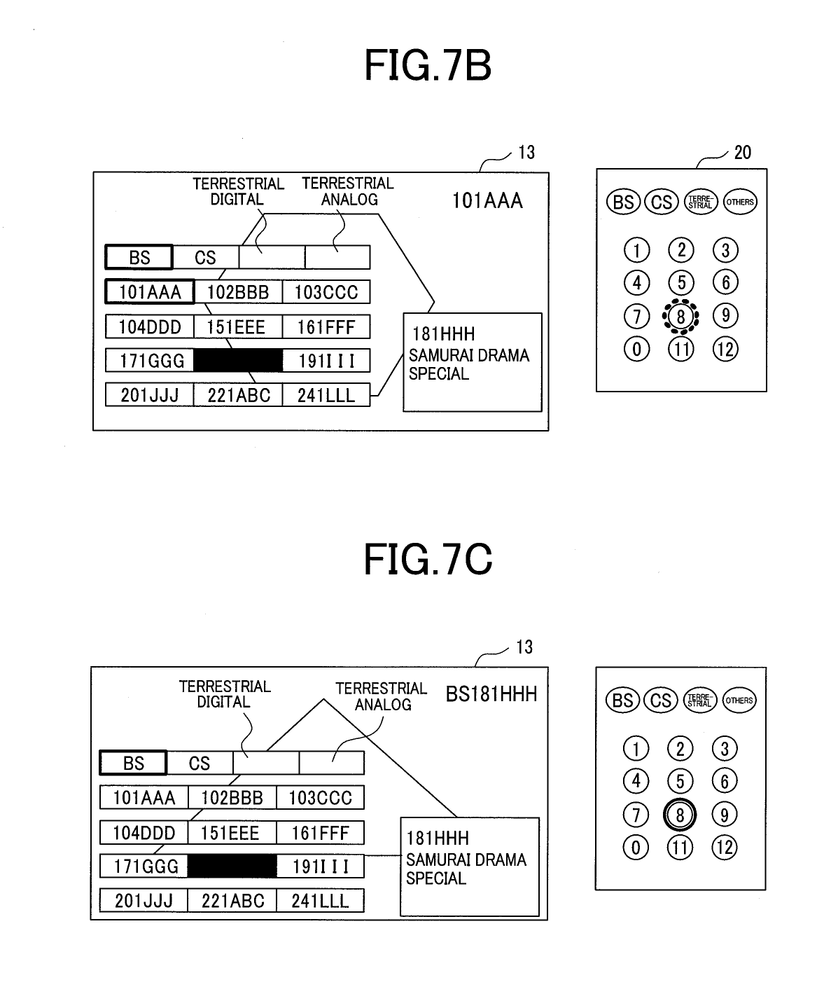

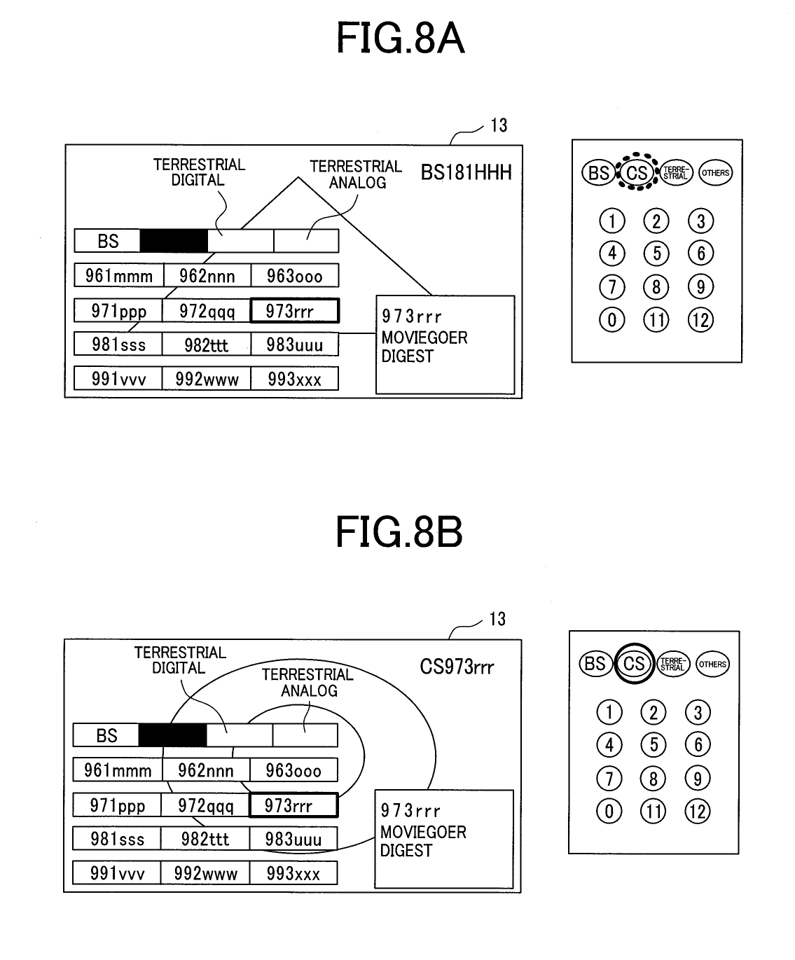

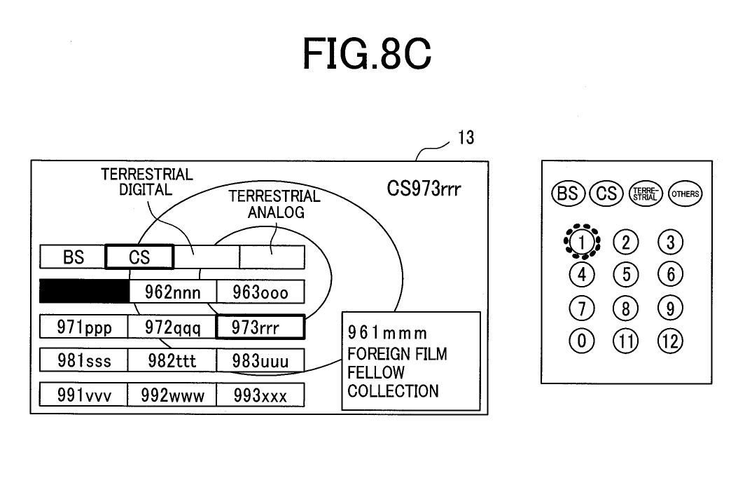

The following describes the digital broadcast receiver 1 of this embodiment with reference to FIGS. 5, 6, 7A to 7C, and 8A to 8C. FIG. 5 is an operation flowchart of the digital broadcast receiver 1 of FIG. 1, and FIGS. 6 to 8C are drawings showing display screen examples corresponding to the operation flowchart of FIG. 5. FIGS. 7A to 8C show the remote controller 20 along with a display screen example.

By operating the power button 44 of the remote controller 20 to turn the power tact switch 45 on, the main body control part 16 is sent into a waiting state (Step S1). In the waiting state, the control part displays in the display part 13 a program video based on a broadcast mode and a channel number having been selected when the power tact switch 45 is previously turned off (in other words, a program video of the last channel number that was viewed in a previous broadcast mode). For example, a display screen example of FIG. 6 shows that the broadcast mode is BS digital broadcast, and a channel number is 101AAA, indicating that the BS tuner 11a₁ is operating as a first tuner. The following describes transition from the display screen example of FIG. 6 with reference to screen examples that follow.

In the waiting state, the control part determines whether the user touches the operation buttons 30 of the remote controller 20 (whether it detects the first operation signal) (Step S2), and keeps the state until the operation buttons 30 are touched (until the first operation signal is detected. In Step S2, on determining that the operation buttons 30 are touched (the first operation signal is detected), the control part determines whether the user touches the broadcast mode button 31 of the remote controller 20 (Step S3).

In Step S3, on determining that the broadcast mode buttons 31 are not touched, the control part determines that the channel buttons 32 rather than the broadcast buttons 31 are touched (the first operation signal by the channel buttons 32 is detected), and proceeds to Step S4.

In Step S4, as shown in FIG. 7A, the control part displays information such as a broadcast mode and a channel number along with a program video being displayed, on a display screen of the display part 13. The display has the same arrangement as the operation button group 30 of the remote controller 20. This arrangement allows the user to intuitively grasp a positional relationship of an operation button 30 (channel) being currently touched without seeing the hands.

In this case, a selected broadcast mode and channel number are displayed with a mark attached (a surrounding frame in FIG. 7A) so that they are easily grasped. In order that the content of a channel number of the touched channel buttons 32 (a channel number 5 in FIG. 7A) is easily grasped, the channel number portion is displayed with a mark attached (shaded in FIG. 7A), and the channel number 151EEE and its program guide information “World cup soccer Japan vs Brazil” are enlarged and displayed. Thus, the user can easily grasp the next program information to display in the waiting state by extremely easy operations without displaying the next program video on a main screen. Along with the display of program information, the control part vocally outputs channel information (e.g., broadcast mode name, channel number, and program guide information) from the voice output part 14. Thus, the user can further easily grasp the next program information to display.

In Step S4, the reception of a program corresponding to the touched channel button 32 is started. In FIG. 7A, the reception of a program of the channel number 151EEE of the BS digital broadcast is started with the BS tuner 11a₂ as a second tuner.

In this state, the control part determines whether the channel button 32 is detouched (the detection of the first operation signal goes out) (Step S5), and when detouched, terminates the screen display and voice output of information corresponding to the touched channel button 32 and returns to Step S2 (Step S6).

Even when the detection of the first operation signal goes out after it is detected, the control part may continue to receive the program by the first tuner 11a₁ until a predetermined time elapses, and if the second operation signal is not detected until the predetermined time elapses, terminate the reception of the program by the second tuner 11a₂. By doing so, even if the user unintentionally separates the finger from the channel button 32 in contact while confirming the next program, the reception of the program by the first tuner 11a₁ is continued, and when the channel button 32 is pushed within the predetermined time, the next program video can be immediately displayed.

The control part returns to Step S2 from Step S6, and when the user touches a different channel button 32, for example, when the user touches a channel button 8 as shown in FIG. 7B, the control part performs the same operation as Step S4, and proceeds to Step S5. In Step S4 in this case, as shown in FIG. 7B, the screen is changed to a channel number 181HHH and its program guide information “Samurai Drama Special.”

When the channel button 32 is determined to be not detouched in Step S5, the control part determines whether the channel button 32 is pushed (whether the second operation signal is detected) (Step S7). When the channel button 32 is not pushed, the control part returns to Step S5 to repeat the above operation.

When the channel button 32 is determined to be pushed in Step S7 (the second operation signal is detected), as shown in FIG. 7C, the control part changes the display of the main screen to a program video having been processed by the second tuner 11a₂ (Step S8).

On the main screen of the display part 13, the program video having been processed by the second tuner 11a₂ is displayed as soon as the decoding of it is completed. By the user's usual operation of touching the channel button 32, then pushing it after confirming program information, the program video is immediately displayed in the display part 13. Even when the user immediately pushes the channel button 32, a touch to the channel button 32 precedes the pushing, so that the program video is displayed in the display part 13 more quickly than conventional. The control part performs control of Step S8, then returns to Step S2.

Information such as the broadcast mode and channel number in FIG. 7C disappears when the user's finger separates from the channel button 32.

When the broadcast buttons 31 are determined to be touched in Step S3, the control part determines that the broadcast buttons 31 rather than the channel buttons 32 are touched (the first operation signal by the broadcast mode buttons 31 is detected), and proceeds to Step S9.

In Step S9, as shown in FIG. 8A, on the display screen of the display part 13, the control part displays information such as a broadcast mode and the last channel number that was previously viewed in the broadcast mode, along with a program video being displayed.

In this case, a selected broadcast mode and channel number are displayed with a mark attached (in FIG. 8A, the broadcast mode is shaded and the channel number is surrounded by a frame) so that they are easily grasped. A channel number 973rrr and its program guide information “Moviegoer Digest” are enlarged and displayed so that program information of a channel number of a touched broadcast mode button 31 (broadcast mode button CS in FIG. 8A) is easily grasped. Thus, the user can easily grasp the next program information to display in the waiting state by extremely easy operations without displaying the next program video on a main screen. Along with the screen display, the control part vocally outputs channel information (e.g., broadcast mode name, channel number, and program guide information) from the voice output part 14. Thus, the user can further easily grasp the next program information to display.

In Step S9, the reception of a program corresponding to the touched broadcast mode button 31 is started. In FIG. 8A, the reception of a program of the channel number 973rrr of the CS digital broadcast is started with the CS tuner 11b₁ as a second tuner. In this case, the BS tuner 11a₂ serves as a first tuner.

In this state, the control part determines whether the broadcast mode button 31 is detouched (the detection of the first operation signal goes out) (Step S10), and when detouched, terminates the screen display and voice output of information corresponding to the touched broadcast mode button 31 and returns to Step S2 (Step S11).

Even when the detection of the first operation signal goes out after it is detected, the control part continues to receive the program by the first tuner 11a₂ until a predetermined time elapses, and if the second operation signal is not detected until the predetermined time elapses, the control part may terminate the reception of the program by the second tuner 11b₁. By doing so, even if the user unintentionally separates the finger from the channel button 32 in contact while confirming the next program, the reception of the program by the first tuner 11a₂ is continued, and when the channel button 32 is pushed within the predetermined time, the next program video can be immediately displayed.

When the broadcast mode button 31 is determined to be not detouched in Step S10, the control part determines whether the broadcast mode button 31 is pushed (whether the second operation signal is detected) (Step S12). When the broadcast mode button 31 is not pushed, the control part returns to Step S10 to repeat the above operation.

When the broadcast mode button 31 is determined to be pushed in Step S12 (the second operation signal is detected), as shown in FIG. 8B, the control part changes the screen display of the display part 13 to a program video having been processed by the second tuner 11b₁ (Step S13).

On the main screen of the display part 13, the program video having been processed by the second tuner 11b₁ is displayed as soon as the decoding of it is completed. In the user's usual operation of touching the broadcast mode button 31, then pushing it after confirming program information, usually a time lag during processing by the second tuner 11b₁ elapses, so that the program video is immediately displayed in the display part 13. Even when the user immediately pushes the broadcast mode button 31, a touch to the broadcast mode button 31 precedes the pushing, so that the program video is displayed in the display part 13 more quickly than conventional. The control part performs control of Step S8, then returns to Step S2.

Information such as the broadcast mode and channel number in FIG. 8B disappears when the user's finger separates from the channel button 32.

The control part returns to Step S2 from Step S13, and when the user touches a channel button 32, for example, when the user touches the channel button 1 as shown in FIG. 8C, the control part performs the same operation as the above-described Step S9, and proceeds to Step S10. In Step S9, as shown in FIG. 8C, the screen has been changed to a channel number 961mmm and its program guide information “Foreign Film Fellow Collection.” Subsequently, the control part performs the same operations as those in and after Step S10 as described above; therefore, a description of them is omitted.

### Second Embodiment

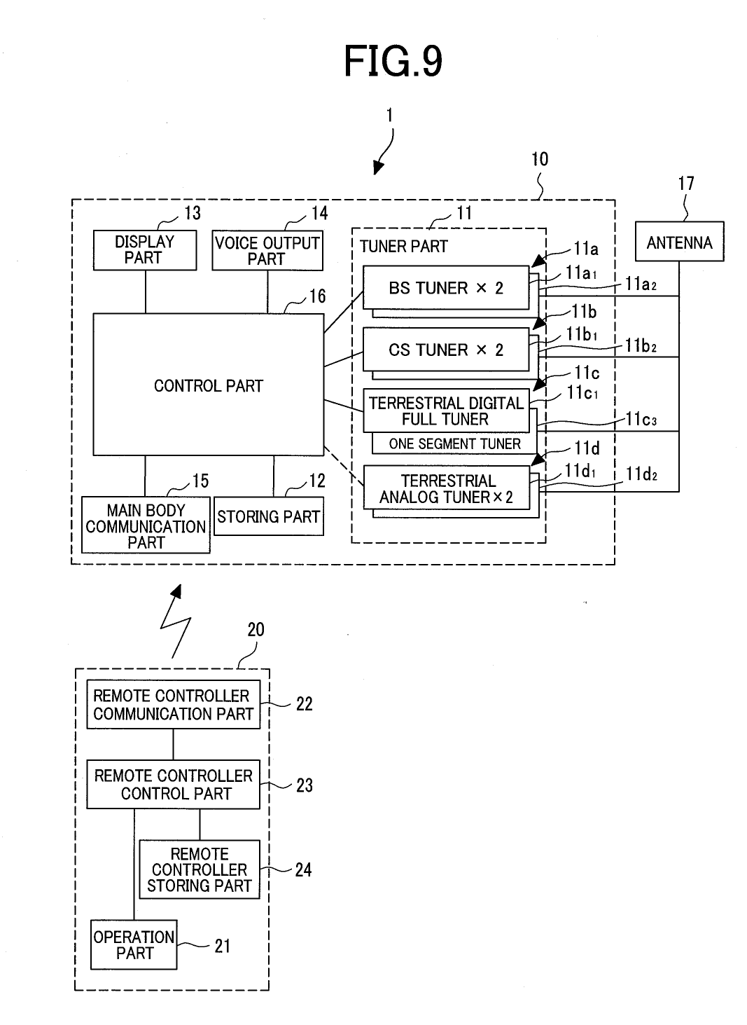

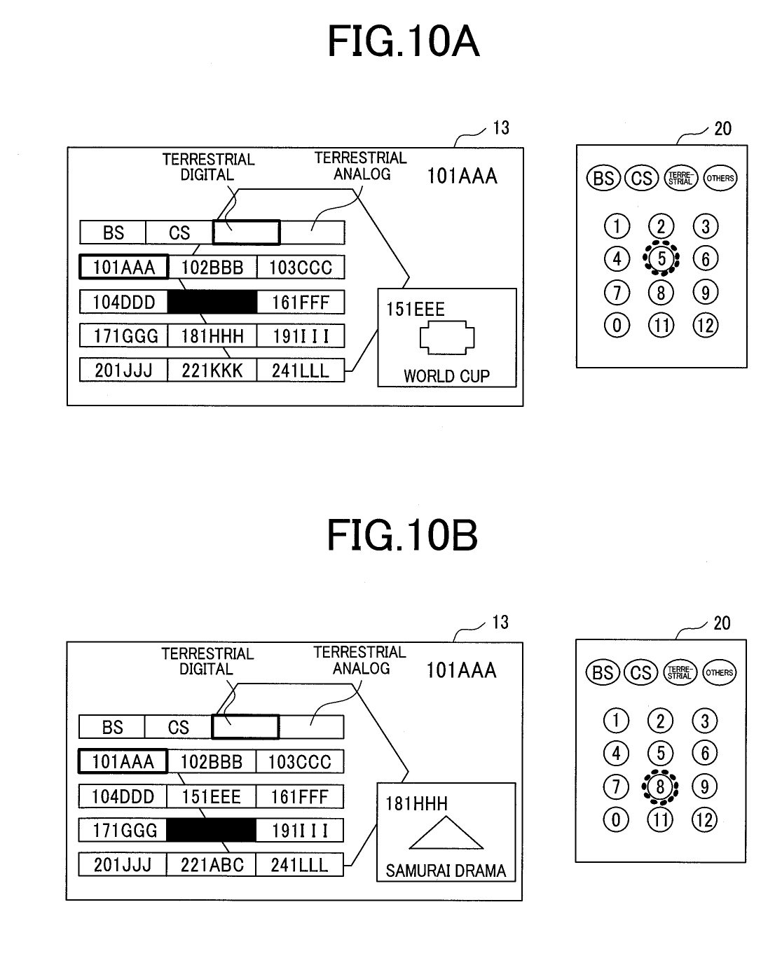

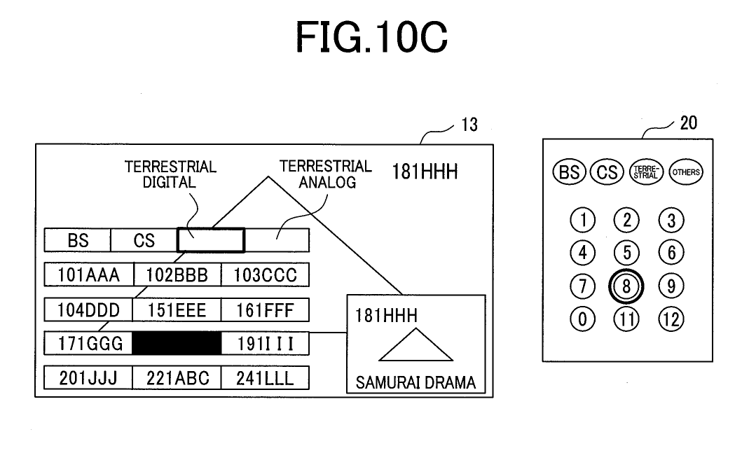

The following describes a digital broadcast receiver 1 of a second embodiment of the present invention with reference to FIGS. 9 and 10. FIG. 9 is a block diagram showing the digital broadcast receiver 1 of the second embodiment of the present invention. FIGS. 10A to 10C are drawings showing screen examples in the digital broadcast receiver 1 of FIG. 9. The second embodiment is different from the first embodiment in points described below, and basically the same as the first embodiment in other points. Therefore, duplicate descriptions are omitted.

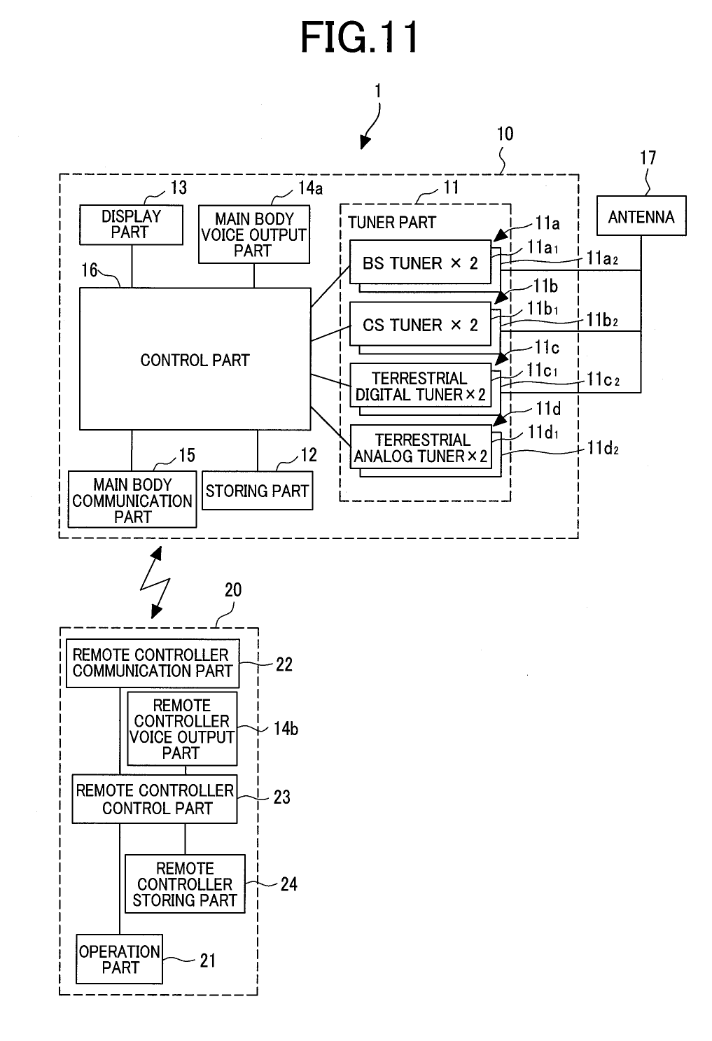

In the second embodiment, a terrestrial digital tuner 11c includes plural digital terrestrial full tuners 11c₁ and 11c₂, and a terrestrial digital one segment tuner 11c₃. A terrestrial digital full tuner 11c₂ is omitted in FIG. 11. The terrestrial digital full tuners 11c₁ and 11c₂, like those shown in the first embodiment, process data contained in a terrestrial digital broadcast received by the antenna 17 in a full version, and have a large time lag until display in the display part 13. On the other hand, the terrestrial digital one segment tuner 11c₃ processes data contained in a terrestrial digital broadcast received by the antenna 17 in a simple version, and has an extremely small time lag until display in the display part 13.

In the second embodiment, instead of the screen example of FIG. 7A in Step S4 of the first embodiment, a preview screen is displayed using the terrestrial digital one segment tuner 11c₃ like a screen example of FIG. 10A. Specifically, the character-based program guide information “World Cup Soccer Japan vs Brazil” is shortened to “World Cup”, and in a resultingly vacated space, a program video simply processed by the terrestrial digital one segment tuner 11c₃ is displayed on a preview screen. Thus, the user can immediately grasp a simple video of the next program video to display by the preview screen. When the first operation signal is detected, along with the terrestrial digital one segment tuner 11c₃, the terrestrial digital full tuner 11c₂ also starts data processing, and the both constitutes a second tuner.

While viewing the preview screen, the user immediately pushes the operation button 30 if he (she) wants to view the program, whereby a program video of a full version having been subjected to data processing by the terrestrial digital tuner 11c₂ can be displayed on the main screen. If the user wants to view other programs, he (she) can change to a different operation button 30 (channel button 8) from the touched operation button 30 (channel button 5), for example, to display of a screen example of FIG. 10B, without displaying the next program video to display on the main screen. As in FIG. 10A, in the screen example of FIG. 10B, character display is shortened, and a program video having been simply processed by the terrestrial digital one segment tuner 11c₃ is displayed.

By pushing the touched operation button (channel button 8), the user can display a program video of a full version on the main screen, as shown in FIG. 10C.

### Third Embodiment

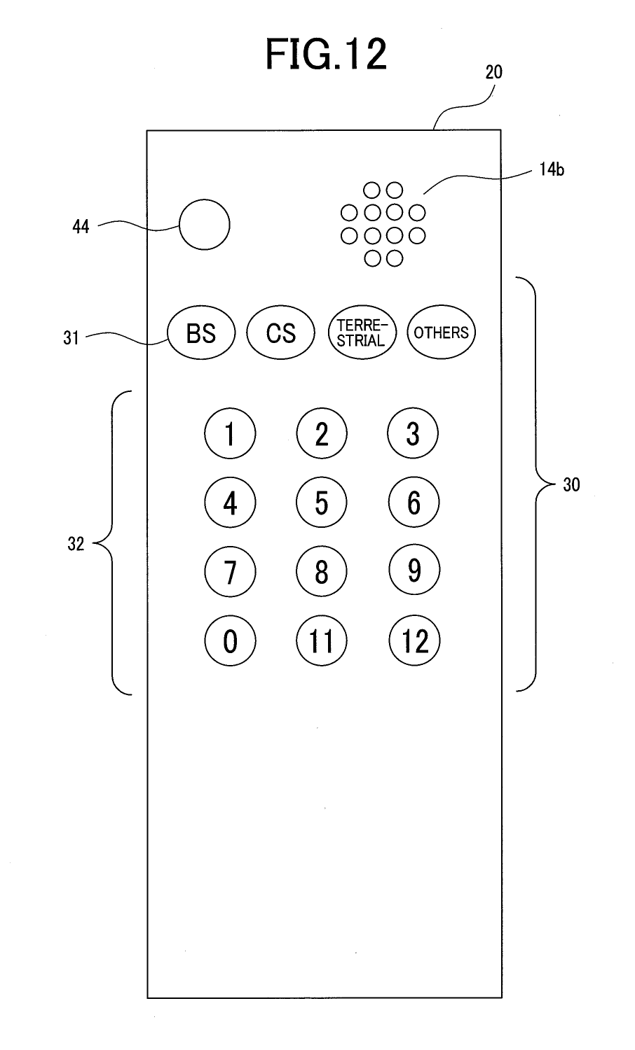

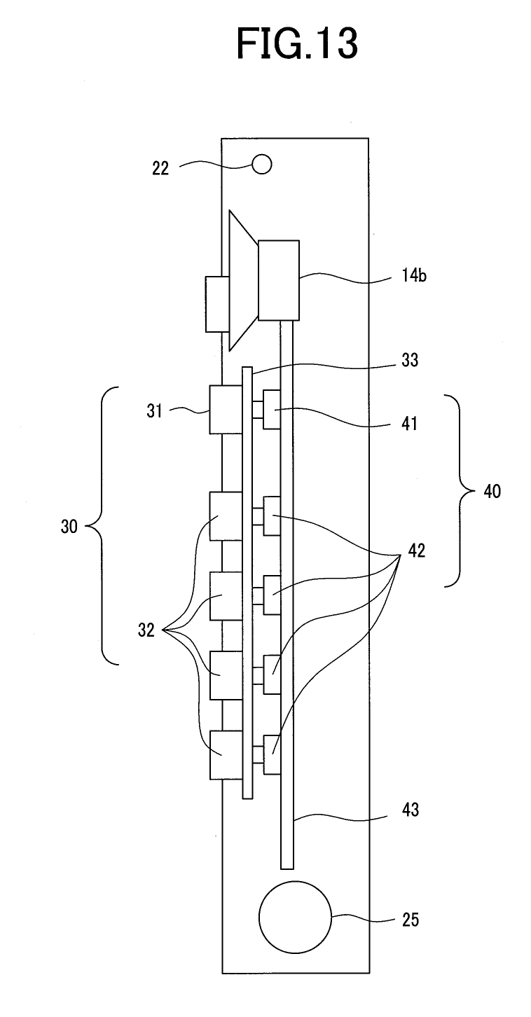

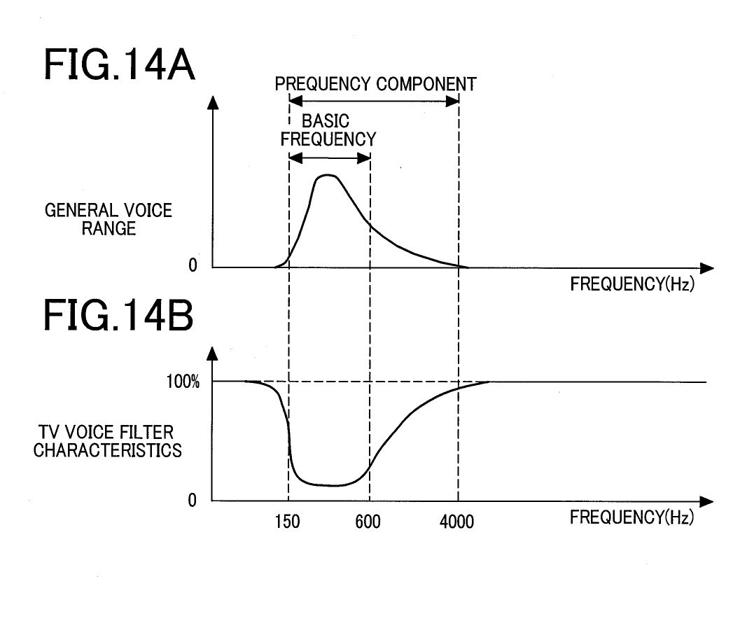

The following describes a digital broadcast receiver 1 of a third embodiment of the present invention with reference to FIGS. 11 to 14. FIG. 11 is a block diagram showing the digital broadcast receiver 1 of the third embodiment of the present invention. FIG. 12 is a plan view of a remote controller of FIG. 11. FIG. 13 is a sectional schematic diagram of the remote controller of FIG. 12. FIG. 14 is a drawing for describing a voice reduction method in the third embodiment. The third embodiment is different from the first embodiment in points described below, and basically the same as the first embodiment in other points. Therefore, duplicate descriptions are omitted.

In the third embodiment, a main body communication unit 15 and a remote controller communication unit 22 are constructed to be capable of wirelessly (by radio) sending and receiving signals to and from each other over an antenna. A voice output part in the digital broadcast receiver 1 includes a main body voice output part 14a being a first voice output part, and a remote controller voice output part 14b being a second voice output part.

The main body voice output part 14a vocally outputs voice information about a program video displayed in the display part 13 according to a control command of the main body control part 16. Voice output by the main body voice output part 14a is basically the same as voice output of the voice output part 14 in the first embodiment, except that voice output about program information is changed to be performed in the remote controller.

The remote controller voice output part 14b, incorporated in the remote controller 20, vocally outputs voice information about a touched operation button 30 according to a control command of the main body control part 16. Specifically, the remote controller voice output part 14b, as shown in FIGS. 12 and 13, includes a loudspeaker connected to a second circuit substrate 43 and outputs voice from the upper surface.

Voice data about program information having been subjected to data processing in the tuner part 11 is sent to the remote controller communication part 22 from the main body communication part 15. The voice data received in the remote controller communication part 22 is converted into voice and outputted in the remote controller voice output part 14b under control of the remote controller control part 23.

Thus, voices having different properties (voice of program video and voice of program information) are differentiated, and voice about program information is outputted from the remote controller at hand. By this construction, the user can easily differentiate voice of program video from voice of program information, and yet can surely listen to voice of program information in which the user to intend to change a program is most interested at the present moment.

The control parts 16 and 23 can make voice outputted from the remote controller voice output part 14b louder than voice outputted from the main body voice output part 14a. By this construction, the user can more surely listen to voice of program information in which the user to intend to change a program is most interested at the present moment.

Furthermore, the control parts 16 and 23 lowers voice outputted from the main body voice output part 14a that is in the same voice range as the range of voice outputted from the remote controller voice output part 14b. Specifically, since it is known that a general voice range becomes high in a basic frequency range of 150 to 600 Hz as shown in FIG. 14A, when voice is outputted from the remote controller output part 14b, voice outputted from the main body voice output part 14a is subjected to a voice filter having small voice filter properties in a basic frequency range of 150 to 600 Hz as shown in FIG. 14B. By this construction, the user can still more surely listen to voice of program information in which the user to intend to change a program is most interested at the present moment.

What is claimed is:

1. A digital broadcast receiver that receives a digital broadcast and processes data contained in the broadcast to display a program video, comprising:
a tuner part having a first tuner and a second tuner;
a display part that displays a program video processed by the tuner part;
an input part having operation buttons for selecting programs; and
a control part that controls them in an integrated manner,
wherein the input part generates a first operation signal when the operation buttons are touched, and generates a second operation signal when the operation buttons are pushed, and
the control part starts the reception of a program corresponding to the first operation signal by the second tuner when detecting the first operation signal during the display of a program video being received over the first tuner, and when detecting the second operation signal, switches to the display of a program video being received over the second tuner.

2. The digital broadcast receiver according to claim 1, further comprising:
the input part, constructed with a remote controller, that has the operation buttons and a remote controller communication part that issues operation signals by operations on the operation buttons; and
a main body communication part that receives operation signals issued from the remote controller communication part and inputs them to the control part.

3. The digital broadcast receiver according to claim 1,
wherein the input part is an input part of two-step action including a pressure touch sensor that generates the first operation signal when the operation buttons are touched, and a tact switch that generates the second operation signal when the operation buttons are pushed.

4. The digital broadcast receiver according to claim 1,
wherein even when the detection of the first operation signal goes out after it is detected, the control part continues to receive the program by the second tuner until a predetermined time elapses, and if the second operation signal is not detected until the predetermined time elapses, terminates the reception of the program by the second tuner.

5. The digital broadcast receiver according to claim 1,
wherein when detecting the first operation signal during the display of a program video being received over the first tuner, the control part displays information about a program corresponding to the first operation signal, along with the program video being displayed.

6. The digital broadcast receiver according to claim 5,
wherein the tuner part includes the first and the second tuners that process data contained in digital broadcasts in a full version, and a third tuner that processes data contained in digital broadcasts in a simple version, and information about the program corresponding to the first operation signal includes a program video of the simple version processed by the third tuner.

7. The digital broadcast receiver according to claim 1, further comprising a voice output part that outputs voice,
wherein the control part vocally outputs information about a program corresponding to the first operation signal from the voice output part when detecting the first operation signal during the display of a program video being received over the first tuner.

8. The digital broadcast receiver according to claim 2,
wherein the main body communication part and the remote controller communication part are constructed to be capable of wirelessly sending and receiving signals to and from each other,
the digital broadcast receiver includes a voice output part having a first voice output part and a second voice output part incorporated in the remote controller, and
the control part vocally outputs voice information about a program video displayed in the display part from the first voice output part, and vocally outputs voice information about a touched operation button from the second voice output part.

9. The digital broadcast receiver according to claim 8,
wherein the control part makes voice outputted from the second voice output part louder than voice outputted from the first voice output part.

10. The digital broadcast receiver according to claim 8,
wherein the control part lowers voice outputted from the first voice output part that is in the same voice range as the range of voice outputted from the second voice output part.
